(19) United States
(12) Patent Application Publication
(10) Pub. No.: US 2003/0232139 A1
(43) Pub. Date: Dec. 18, 2003

(54) Shield and method for spraying coating on a surface

(76) Inventor: Frank Anthony DeTura, Port St. Lucie, FL (US)

Correspondence Address: Mitchell D. Bittman, Patent Dept., Sequa Corporation, 3 University Plaza, Hackensack, NJ, 07601, US

(21) Appl. No.: 10/171,234

(22) Filed: Jun. 13, 2002

(51) Int. Cl. B05D 1/02; B05D 1/32

(52) U.S. Cl. 427/282; 118/504; 427/421

(57) ABSTRACT

A shield is provided for spraying of a coating on a surface of a substrate, the shield having a lower portion which is adapted to be disposed adjacent to the surface to be coated; an upper portion which is adapted to be disposed above the edge of the raised surface; and a middle portion extending from and connecting the upper portion to the lower portion that is indented and spaced away from the upper portion and the edge of the surface to be coated. A method is provided comprising installing this shield and spraying a coating on the substrate surface.

### BACKGROUND OF THE INVENTION

This invention relates to a shield for use in spraying of a coating on a surface and the method of using the shield in spraying a coating.

Gas turbine engines have components which require the application of a coating, such as a thermal barrier ceramic coating, onto a surface by a spraying process, such as plasma spraying. For example, as shown in FIG. 6, a combustor inner sub assembly 11 of a certain gas turbine engine has a band 12 which is a raised surface and requires the application of a ceramic thermal barrier coating (e.g. MCrAlY bond coat and yttria-stabilized zirconium top coat) by air plasma spraying. In accordance with standard practices, as shown in FIG. 4, the adjoining surfaces of the combustor assembly 11 are masked by applying a thermal resistant tape 13, or a paint, metal mask, or other material to prevent these adjoining surfaces from being coated. While these methods of masking are effective in protecting the area which is not to be coated, the spraying process will result in a coating 15 having a rough edge at the raised surface edge 17 with overhanging coating 16 caused by “bridging” onto the top of the maskant. As a result, the part requires subsequent blending (machining) to remove the overhanging coating and rough edge, which is time consuming and labor intensive.

In an alternate, as shown in FIG. 5, a maskant 18 is raised above the surface edge 19. However, this method results in a coating 20 having a fillet radius 21 abutting the maskant. This fillet radius is also undesirable and requires blending to remove.

Thus, it is an object of this invention to provide a shield and method of spraying a coating which minimizes adverse effects that can exist at the edge of a sprayed coating and the need for subsequent blending of the coating.

### SUMMARY OF THE INVENTION

Briefly, this invention provides a shield for use in spraying of a coating on a surface of a substrate, the shield having: a lower portion which is adapted to be disposed adjacent to an edge of the surface to be coated; an upper portion which is adapted to be disposed above the edge of the surface to be coated; and a middle portion extending from and connecting the upper portion to the lower portion that is indented and spaced away from the upper portion and the edge of the surface to be coated. A method is provided comprising installing this shield and spraying a coating on the substrate surface.

### BRIEF DESCRIPTION OF THE DRAWINGS

In the drawings that form part of the description of an illustrative embodiment and wherein like reference numbers refer to like structural elements:

FIG. 1 is a cross sectional view of the shield of the invention;

FIG. 2 is a cross sectional view of the shield installed adjacent to a raised surface during coating;

FIG. 3 is a cross sectional view of the shield installed adjacent to a collinear surface during coating;

FIG. 4 is a cross sectional view showing the coating applied when a maskant is installed in accordance with standard practices;

FIG. 5 is a cross sectional view showing the coating applied when a maskant is installed raised above the surface edge; and

FIG. 6 illustrates a combustor inner sub-assembly having a raised surface to be coated representing an example of a turbine component that can be efficiently coated in accordance with the invention.

### DETAILED DESCRIPTION OF THE INVENTION

A shield is provided for installation adjacent to a surface of a substrate to be spray coated to minimize adverse effects at the surface edge and avoid the formation of an overhang or fillet of coating material on the edge of the coating surface or a rough edge caused by the bridging of coating material onto the maskant, thus minimizing the need for subsequent machining or blending of the coating.

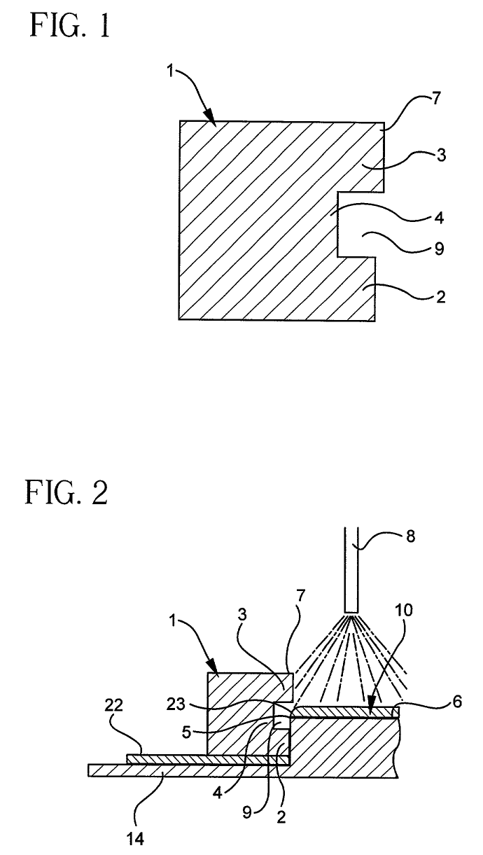

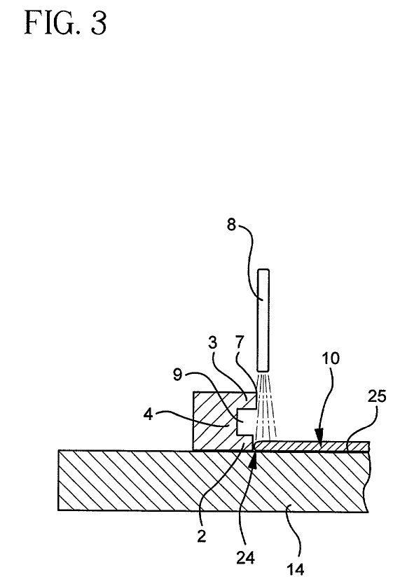

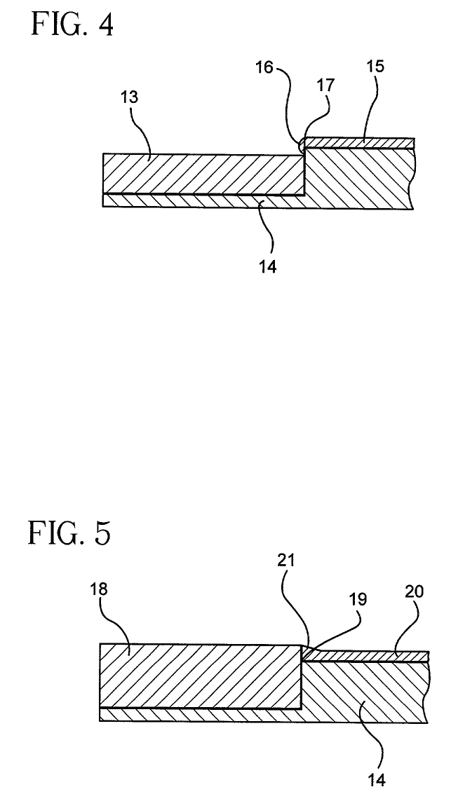

The shield 1, as depicted in FIG. 1, comprises three sections, a lower portion 2, an upper portion 3 and a middle portion 4. The lower portion 2 in an installed position, as depicted in FIG. 2, is adapted to be disposed adjacent to and below the edge 5 of a raised surface 6 of the substrate 14 or, as depicted in FIG. 3, is adapted to be disposed adjacent to the desired coating edge 24 of the collinear surface 25 of the substrate 14. The bottom corner of the lower portion 3 can also be beveled to facilitate fitting the shield against the raised surface 6 or the coating edge 24. The upper portion 3 in an installed position is adapted to be disposed above the edge 5 of the raised surface 6 as shown in FIG. 2, or above the desired coating edge 24 of the collinear surface 25 as shown in FIG. 3, at a height greater than that of surface of the coating 10 after application. The upper portion 3 may overhang 7, or be spaced away from, the edges 5 or 24 to control the location of the coating edge on the surface to be coated. The amount the upper portion 3 overhangs 7, or is spaced away from, the edge 5 or 24 will depend on the orientation of the spray device with respect to the shield and the surface to be coated, as well as the exit velocities of the coating particles from the spray device, typically from a nozzle 8. The middle portion 4 extends from and connects the upper portion 3 to the lower portion 2 and is indented and spaced away from the upper portion 3 and the edge 5 of the raised surface 6 or the desired coating edge 24 of the collinear surface 25 in an installed position forming an indented region or pocket 9. In a typical plasma spray process the middle portion 4 can be spaced at about 0.05 to 0.5 inches away from the upper portion 3. Overspray can accumulate in the indented region 9 avoiding accumulation of coating material at the edges 5 or 24. The middle portion 4 provides relief and collection of excessive coating deposit that may accumulate during the spraying process and its dimensions preferably are proportional to the total coating thickness.

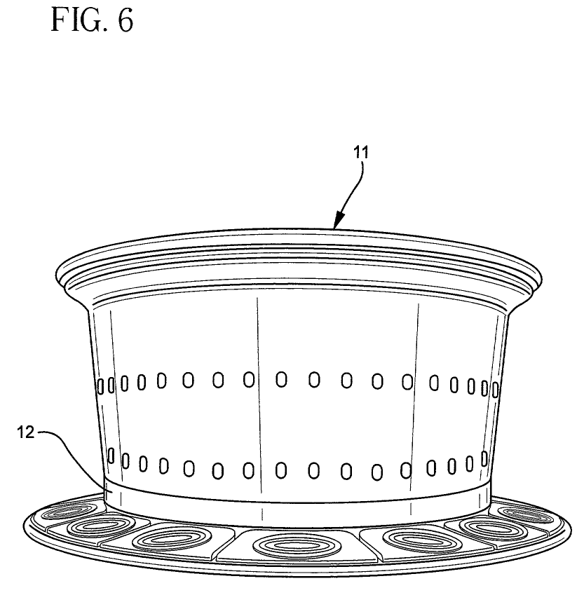

The shield 1 is useful in spraying coating on a raised surface of a turbine component. As shown in FIG. 6, the shield can be used in the coating of a band 12 of a combustor inner sub assembly 11. The coating to be applied can be any typically applied by a spraying process. For example, the coating can be a ceramic thermal barrier coating comprised of a metallic bond coat and a ceramic top coat, a metallic coating (e.g. an MCrAlY coating), a paint, a dry film lubricant, or an adhesive. The spraying process can include plasma spraying (air or low pressure), sputtering, HVOF (high velocity oxyfuel), wire arc, aerosol, and conventional spraying (application of a coating, typically paint, with the aid of compressed gas).

For ease of installation the shield can be of a flexible material and particularly when a high temperature spraying process is employed, such as plasma spraying, the material should also be temperature resistant. A suitable shield material for plasma spraying is a flexible, high temperature resistant silicon. The shield can be manufactured as a unitary piece which is applied to the substrate by stretching over or around the substrate, compressing against a substrate (as might be required for masking the inner diameter of a combustor liner), or alternatively, with an adhesive 22 as shown in FIG. 2. A typical shield will have a width of from about 1 to 5 inches with each of the lower, middle and upper portions having a height of from 0.15 to 0.5 inches

The coating process is carried out by installing the shield 1 adjacent to the edge 5 of surface 6 or edge 24 of surface 25 to be coated followed by spraying the coating on the substrate surface. Advantageously the coating 10 will have a tapered smooth profile 23 at the edge 5 or 24. This process will save considerable time and expense previously required to blend the coated part to the desired dimensions.

What is claimed is:

1. A shield used in spraying of a coating on a surface of a substrate comprising:
a lower portion which is adapted to be disposed adjacent to an edge of the surface to be coated;
an upper portion which is adapted to be disposed above the edge of the surface to be coated; and
a middle portion extending from and connecting the upper portion to the lower portion that is indented and spaced away from upper portion and the edge of the surface to be coated.

2. Shield of claim 1 wherein the shield is a high temperature resistant flexible material.

3. Shield of claim 2 wherein the upper portion overhangs the edge of the surface to be coated.

4. Shield of claim 3 wherein the substrate surface to be coated is a raised surface and the lower portion of the shield is disposed adjacent to and below the edge of the raised surface.

5. Shield of claim 4 wherein the raised surface is a band on a turbine combustor.

6. Shield of claim 3 wherein a bottom corner of the lower portion is beveled.

7. Shield of claim 2 wherein an adhesive is applied to the lower portion for securing the shield adjacent to the edge of the surface to be coated.

8. Shield of claim 2 wherein the middle portion is spaced away from the upper portion by about 0.05 to 0.5 inches.

9. A method of spraying a coating on a surface of a substrate comprising:
installing a shield adjacent to an edge of the surface to be coated, the shield having a lower portion adapted to be disposed adjacent to the edge of the surface, an upper portion adapted to be disposed above the edge of the surface and a middle portion extending from and connecting the upper portion to the lower portion that is indented and spaced away from the upper portion and the edge of the surface; and
spraying a coating on the substrate surface.

10. Method of claim 9 wherein the spraying is a plasma spraying process.

11. Method of claim 10 wherein the shield is of a high temperature resistant flexible material.

12. Method of claim 11 wherein the shield is installed using an adhesive applied to the lower portion.

13. Method of claim 9 wherein the upper portion of the shield overhangs the edge of the surface to be coated.

14. Method of claim 11 wherein the shield is installed adjacent to a collinear surface.

15. Method of claim 14 wherein a bottom corner of the lower potion is beveled.

16. Method of claim 15 wherein the coating is a ceramic thermal barrier coating.

17. Method of claim 10 wherein the substrate is a turbine component.

18. Method of claim 16 wherein the turbine component is a combustor.

19. A method of spraying a coating on a raised surface of a substrate comprising:
installing a shield adjacent to an edge of the raised surface to be coated, the shield having a lower portion adapted to be disposed adjacent to and below the edge of the raised surface, an upper portion adapted to be disposed above the edge of the raised surface and a middle portion extending from and connecting the upper portion to the lower portion that is indented and spaced away from the edge of the raised surface; and
spraying a coating on the substrate surface.

20. Method of claim 19 wherein the spraying is a plasma spraying process.

21. Method of claim 20 wherein the shield is of a high temperature resistant flexible material.

22. Method of claim 21 wherein the shield is installed using an adhesive applied to the lower portion.

23. Method of claim 19 wherein the upper portion of the shield overhangs the edge of the raised surface.

24. Method of claim 23 wherein the coating is a ceramic thermal barrier coating.

25. Method of claim 24 wherein the substrate is a turbine component.

26. Method of claim 25 wherein the turbine component is a combustor.

27. Method of claim 26 wherein the raised surface is a band on the combustor.

28. Method of claim 22 wherein a bottom corner of the lower potion is beveled.
